(19) United States
(12) Patent Application Publication
(10) Pub. No.: US 2017/0051545 A1
(43) Pub. Date: Feb. 23, 2017

(54) METHOD AND APPARATUS FOR A DOOR BARRICADE

(71) Applicant: Robert E. Van Buren, Northborough, MA (US)

(72) Inventor: Robert E. Van Buren, Northborough, MA (US)

(21) Appl. No.: 15/209,173

(22) Filed: Jul. 13, 2016

Related U.S. Application Data
(60) Provisional application No. 62/207,087, filed on Aug. 19, 2015.

(51) Int. Cl. E05C 19/00

(52) U.S. Cl. CPC E05C 19/003

(57) ABSTRACT

A security device for barring the door of a doorway and, specifically, to a door barricade device for an outwardly swinging door to prevent unauthorized opening of the door.

### RELATED PATENT APPLICATION

This application claims the benefit of U.S. Provisional Patent Application No. 62/207,087 filed Aug. 19, 2015 entitled A BARRICADE DEVICE FOR SCHOOL CLASSROOM DOORS TO PREVENT UNWANTED PERSONS DURING CODE RED which is hereby incorporated herein by reference in the entirety.

### FIELD OF THE INVENTION

The present invention relates generally to security devices for barring the door of a doorway and, specifically, to a door barricade device for an outwardly swinging door to prevent unauthorized opening of the door.

### BACKGROUND OF THE INVENTION

The security of children within a classroom environment is the most important responsibility of any teacher or faculty member of a school. The present invention provides a useful and efficient device to barricade children safely within a classroom and prevent entry into a classroom by an armed intruder or other unwanted person during an emergency such as a code yellow or code red event. During an attack on a school seconds count and make the difference between survivors and casualties. Many of the security devices of the prior art are heavy and difficult to put into place on a door in the mere seconds it takes to place the door barricade of the present invention, that may be referred to herein as the Van Buren Barricade. In U.S. Pat. No. 7,770,420 to Carr a complicated device having a bar supporting a J-shaped clamping member and a clamping mechanism is disclosed. The door knob of a door is secured by extending the J-shaped clamping member around the door knob and then inserting the end of clamping member through the clamping mechanism and inserting a pad lock through the clamping member to secure the door and prevent the door knob from being turned. The number of parts and complexity of the Carr lockdown door bar device appears difficult to install in an emergency and may be much more expensive than the barricade of the present invention, making it unsuitable for most schools. Other devices such as in U.S. Pat. No. 4,856,831 to Roden Jr. and U.S. Patent Publication No. 2015/0376923 to Presutti require the permanent attachment of fixtures to the door and/or around the door jamb adding installation costs to the costs of the device that many school districts may be unable to afford. The present invention addresses issues of complexity, ease of use and costs providing for the Van Buren Barricade of the present invention to be suitable for any classroom. The Van Buren Barricade is light weight, easily stored, and easily retrieved. It renders the door immovable when put in place in seconds and secures the classroom from outside entry.

### SUMMARY OF THE INVENTION

The present invention provides a method and apparatus to barricade an outward swinging door in an emergency to prevent an unauthorized person from entering. In a preferred embodiment the Van Buren Barricade is made from wood, but metal or other composites such as square tube piping of polyvinyl chloride (PVC) or other similarly resilient materials may be used to manufacture the barricade device. The Van Buren Barricade is therefore lightweight, easy to manufacture and inexpensive enough to have even less affluent schools afford the barricade device for every one of their classrooms, or alternatively make the security devices within their own school wood, plastic, or metal fabrication facilities. Barricades of the prior art that are made of heavy components and that have complex components may be difficult for an older or less agile person to lift and manipulate particularly in a highly stressful emergency situation where people's lives may be at risk. The Van Buren Barricade may be installed on doors having door knobs or door handles and work equally as well to prevent the door from being opened.

The Van Buren Barricade is easily installed by having a person such as a teacher or other faculty member simply pick up the barricade device from a storage location in the classroom and place it over the door handle to secure the door. The Van Buren Barricade renders the door immovable when put in place in seconds and secures the classroom from outside entry preventing an intruder or other unauthorized person outside of the room from opening the door thereby safely securing the occupants within the room. The present invention differs from the prior art in that there are no barricades that are as simple, as quick to install or as effective as the Van Buren Barricade.

It is an object and advantage of the present invention to provide a barricade device that is suitable and affordable for any classroom or for other facilities such as hospitals, office buildings, departments of government, entertainment locals and other public buildings concerned with security in an emergency.

It is an object and advantage of the present invention to provide a barricade device that is easily stored to make it readily accessible in an emergency.

It is an object and advantage of the present invention to provide a barricade device having no complex parts to manipulate by twisting, inserting, or otherwise adjusting to secure an outward swinging door to prevent the door from being opened.

It is an object and advantage of the present invention to provide a barricade device that is lightweight and easily handled to put into place on an outward swinging door to prevent the door from being opened.

It is an object and advantage of the present invention to provide a barricade device that is secured over a door knob or door handle and aligns along the door jamb to prevent the door from being opened.

It is an object and advantage of the present invention to provide a method of manufacture of a barricade device with limited complexity and using a minimal number of components.

It is an object and advantage of the present invention to provide to provide a method of manufacture of a barricade device that uses a single board, square tube, or round pipe that is cut to adequate lengths to form the components of the barricade of the present invention.

It is an object and advantage of the present invention to provide a method of manufacture of a barricade device that uses only bolts to assemble the barricade without any complex mechanisms to secure the barricade to the door.

The present invention relates to a door barricade comprising a brace; at least one spacer affixed to the brace; a latch affixed to the at least one spacer, the latch having a slot; and wherein the slot of the latch is inserted over a door handle, and the brace is secured against a door jamb to secure a door in a closed position. No further adjustment of the brace, spacers or latch of the door barricade is needed to secure the door in a closed position. The brace, at least one spacer and the latch of the door barricade may be formed from a single piece of board, rod, or tube. The number of spacers used in the door barricade is determined by the offset distance from the surface of the door to the face of the interior casing. The door barricade may further comprise at least one bolt and at least one thumb screw to affix the latch to the spacer and the spacer to the brace. The thumb screw may secure the bolt by hand tightening. The door barricade may comprise two bolt holes aligned through each of the brace, at least one spacer and latch. The two bolt holes may be positioned on either side and above the slot of the latch. The two bolt holes may be at a distance closer to the top of the brace, the top of the at least one spacers and the top of the latch. The latch of the door barricade has tangs that form the slot and an outer surface of one of the tangs is in contact with the interior surface of the door jamb. The brace of the door barricade may have notches.

The present invention further relates to a door barricade comprising a board that is cut to form a brace, at least one spacer, and a latch having a slot; and wherein the at least one spacer is affixed to the brace, the latch is affixed to the at least one spacer, and the slot of the latch is inserted over a door handle, and the brace is secured against a door jamb to secure a door in a closed position. No further adjustment of the brace, spacers or latch of the door barricade is needed to secure the door in a closed position. The number of spacers for the door barricade is determined by the offset distance from the surface of the door to the face of the interior casing. The door barricade may comprise at least one bolt and at least one thumb screw to affix the latch to the spacer and the spacer to the brace by hand tightening. The door barricade may comprise two bolt holes aligned through each of the brace, at least one spacer and latch; and wherein the two bolt holes are on either side and above the slot of the latch, and at a distance closer to the top of the brace, the top of the at least one spacers and the top of the latch.

The present invention relates to a method of making a door barricade, comprising cutting a board to form a brace, at least one spacer and latch; forming a slot in the latch; affixing the brace to the at least one spacer, affixing the spacer to the latch, and inserting the door handle of a door into the slot and aligning the brace against a door jamb of the door to prevent the door from being opened. The method of making a door barricade may comprise forming the slot by drilling a hole in the latch; and cutting from a bottom edge of the latch to points on the circumference at the diameter of the hole. The method of making a door barricade may comprise drilling at least one bolt hole through each of the brace, at least one spacer and latch so that the bolt holes are an equal distance from the top and sides of each of the brace, at least one spacer and latch to insert a bolt through the bolt hole and affix the at least one spacer to the brace and the latch to the at least one spacer. The method of making a door barricade, comprising drilling a first bolt hole through each of the brace, at least one spacer and latch so that the bolt holes are an equal distance from the top and a side of each of the brace, at least one spacer and latch to insert a bolt through the bolt hole and affix the at least one spacer to the brace and the latch to the at least one spacer; drilling a second bolt hole through each of the brace, at least one spacer and latch so that the bolt holes are an equal distance from the top and the other side of each of the brace, at least one spacer and latch to insert a bolt through the bolt hole and affix the at least one spacer to the brace and the latch to the at least one spacer. The method of making a door barricade may comprise routing out notches in the brace.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE INVENTION

Various other objects, features and attendant advantages of the present invention will become fully appreciated as the same becomes better understood when considered in conjunction with the accompanying drawings, in which like reference characters designate the same or similar parts throughout the several views, and wherein:

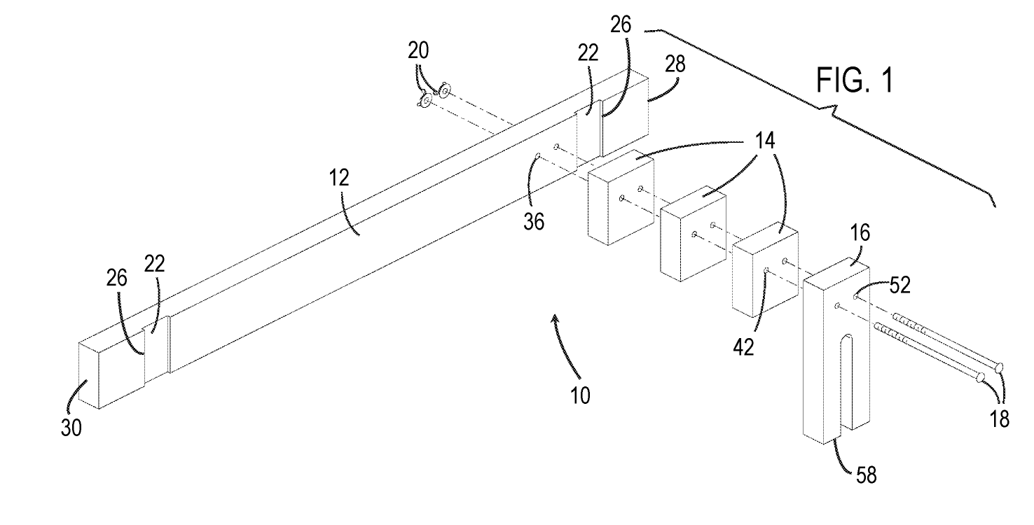

FIG. 1 is an exploded view showing the assembly of parts of an embodiment of the Van Buren Barricade of the present invention;

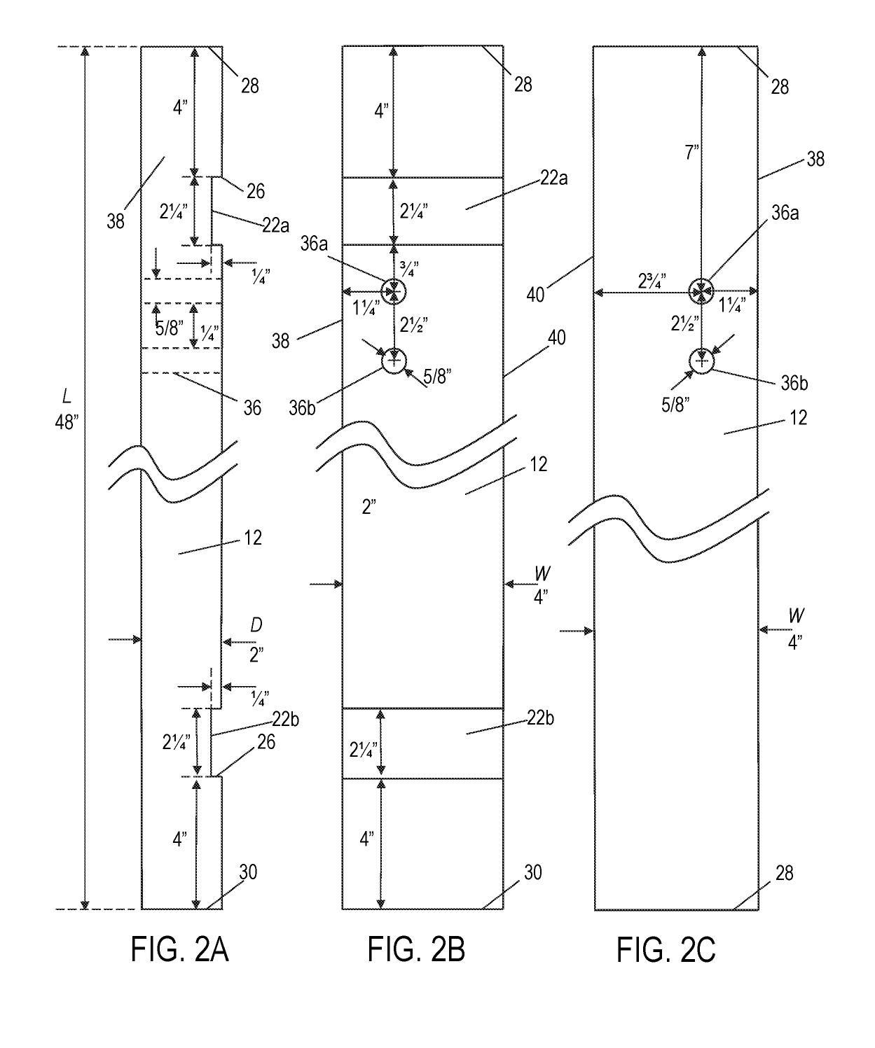

FIG. 2A is a side view of an embodiment of a brace in an embodiment of the Van Buren Barricade of the present invention;

FIG. 2B is a front view of an embodiment of a brace in an embodiment of the Van Buren Barricade of the present invention;

FIG. 2C is a rear view of an embodiment of a brace in an embodiment of the Van Buren Barricade of the present invention;

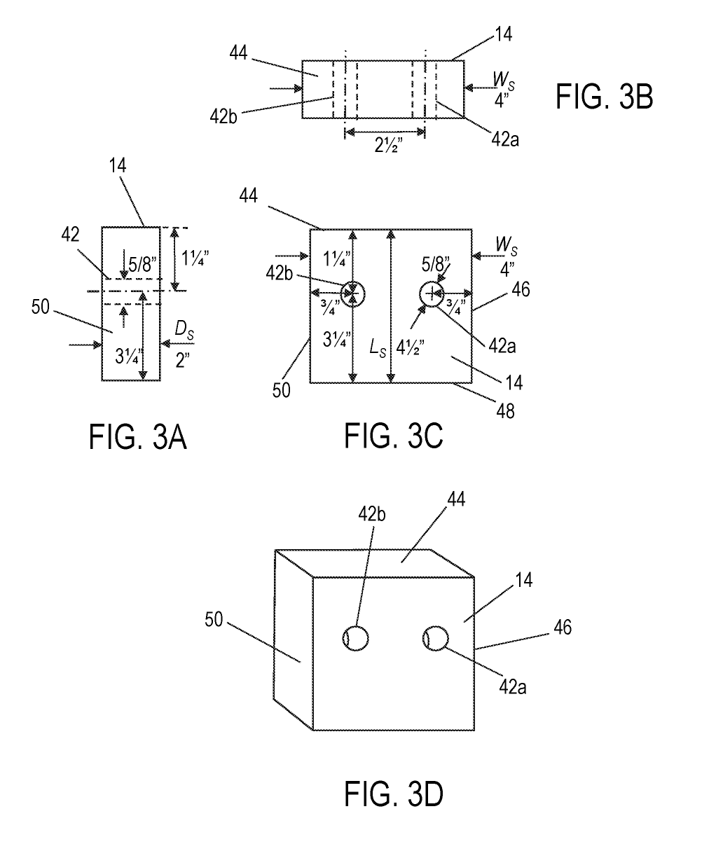

FIG. 3A is a side view of an embodiment of a spacer in an embodiment of the Van Buren Barricade of the present invention;

FIG. 3B is a top view of an embodiment of a spacer in an embodiment of the Van Buren Barricade of the present invention;

FIG. 3C is a front view of an embodiment of a spacer in an embodiment of the Van Buren Barricade of the present invention;

FIG. 3D is a perspective view of an embodiment of a spacer in an embodiment of the Van Buren Barricade of the present invention;

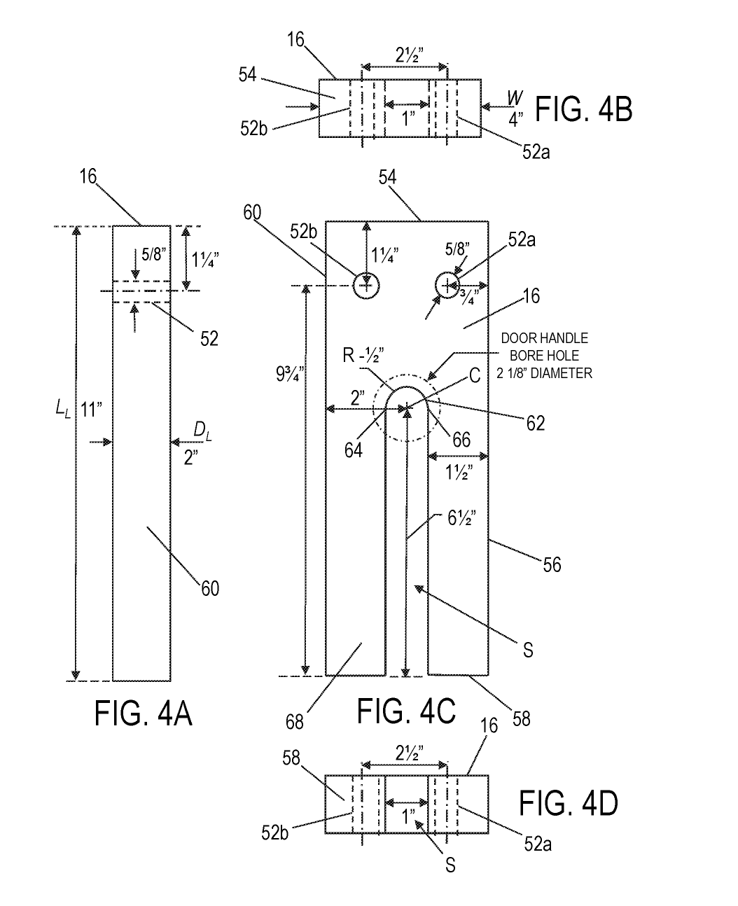

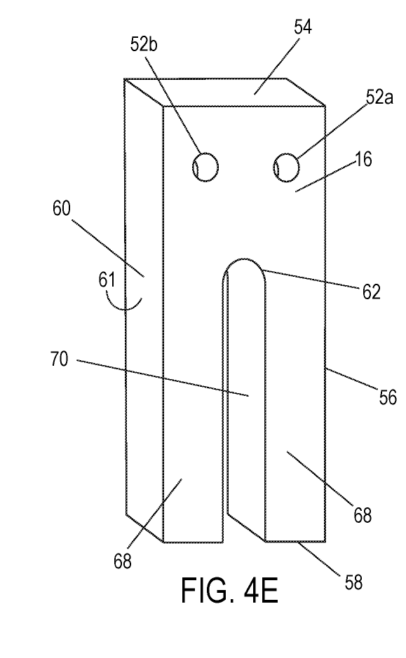

FIG. 4A is a side view of an embodiment of a latch in an embodiment of the Van Buren Barricade of the present invention;

FIG. 4B is a top view of an embodiment of a latch in an embodiment of the Van Buren Barricade of the present invention;

FIG. 4C is a front view of an embodiment of a latch in an embodiment of the Van Buren Barricade of the present invention;

FIG. 4D is a bottom view of an embodiment of a latch in an embodiment of the Van Buren Barricade of the present invention;

FIG. 4E is a perspective view of an embodiment of a latch in an embodiment of the Van Buren Barricade of the present invention;

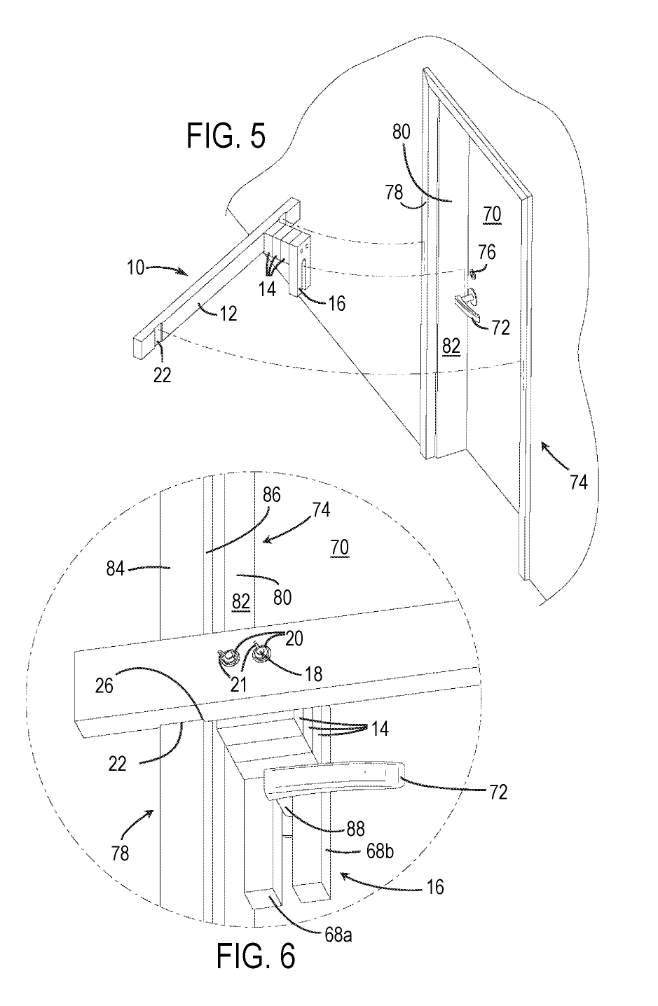

FIG. 5 is a perspective view of an embodiment of the Van Buren Barricade of the present invention prepared for installation on a door;

FIG. 6 is a detailed view of an embodiment of the Van Buren Barricade of the present invention installed over a door handle;

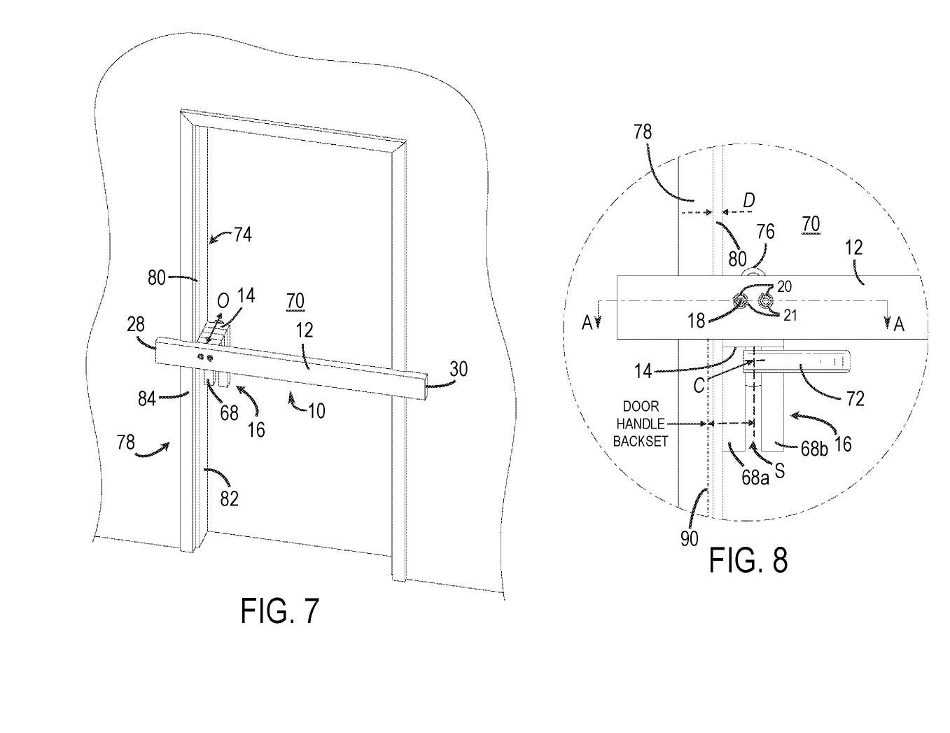

FIG. 7 is a perspective view of an embodiment of the Van Buren Barricade of the present invention installed on a door;

FIG. 8 is a detailed view of an embodiment of the Van Buren Barricade of the present invention installed over a door handle; and

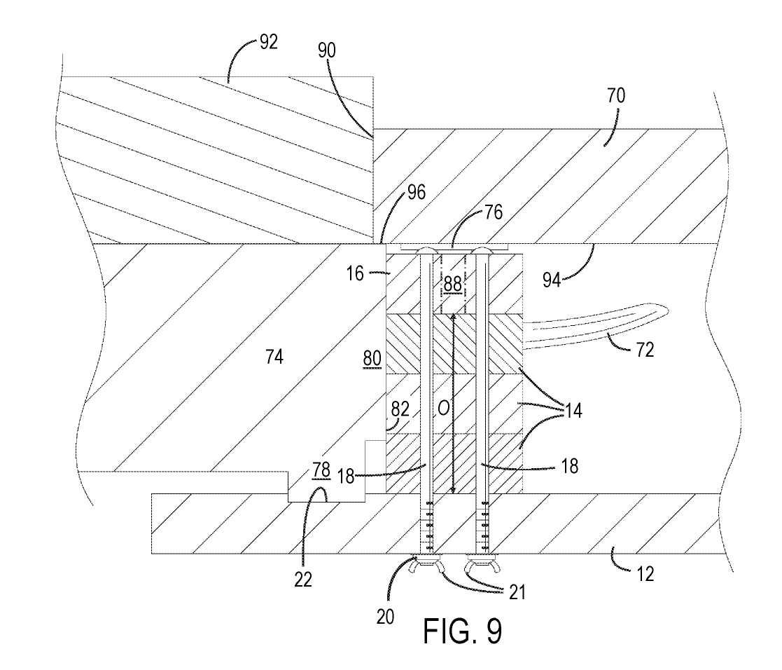

FIG. 9 is a detailed cross-sectional view along section A-A of FIG. 8 in an embodiment of the Van Buren Barricade of the present invention installed over a door handle.

### DETAILED DESCRIPTION OF THE INVENTION

As shown in FIG. 1, the Van Buren Barricade 10 comprises a brace 12, one or more spacers 14, and a latch 16. Two carriage bolts 18 or other attachment fixtures, or adhesives secure the latch 16 with one or more spacers 14 to the brace 12 using two butterfly nuts 20 commonly referred to as thumb screws or other fasteners. The Van Buren Barricade 10 is different from the prior art in that the components may be formed from a single board, rod or pipe that is long enough to cut to form the brace 12, spacers 14 and latch 16, making the Van Buren Barricade very inexpensive to manufacture. For example, an 8-foot length of a 2″×4″ or 2″×6″ wooden board, or of a ½″ to 1¼″ square metal rod or ¾″ to 1½″ of polyvinyl chloride (PVC) square tube or of any other rigid material with sufficient tensile strength to not deform or break could be used to manufacture the barricade device 10. As shown in FIGS. 2A-2C, in an embodiment of the Van Buren Barricade 10, a 2×4 wooden board of a standard size of 8-feet (96″) in length, 2″ in depth D and 4″ in width W could be cut to a length L of approximately 48″ which is 12″ longer than the width of 36″ of a standard door 70, thereby extending the brace 12 beyond the width of the door 70 at either end. If desired, notches 22 may be formed in the brace 12. The sidewalls 26 of the notches 22 may be routed to a depth of approximately ¼″ and a width of 2¼″ to be slightly wider than the interior casing 78 of a door jamb 74 as described herein. The outer sidewall 26 of a first notch 22a is routed at distance of 4″ from the right end 28 of the brace 12. The outer sidewall 26 of a second notch 22b is routed at distance of 4″ from the left end 30 of the brace 12. Two bolt holes 36 each having a ⅝″ diameter are drilled through the brace 12 for attachment of the spacers 14 and latch 16 using carriage bolts 18. A first bolt hole 36a is drilled at a distance of ¾″ from a center point of the first bolt hole 36a to the sidewall 26 of one of the notches 22, 1¼″ from the top 38 of the brace 12, and 2¾″ from the bottom 40 of the brace 12. As shown in a rear view of the brace 12 in FIG. C, the center of the first bolt hole 36a is therefore 7″ from the right end 28 of the brace 12. A second bolt hole 36b is drilled 2½″ from the center of the first bolt hole 36a at a similar distance of 1¼″ from the top 38 and 2¾″ from the bottom 40 of the brace 12.

One or more spacers 14 are cut to a length Ls of 4½″ from the remaining portion of the wooden board. The spacer 14 therefore has the same depth Ds of 2″ and width Ws of 4″ as shown in FIGS. 3A-3C. Two bolt holes 42, each having a ⅝″ diameter, are drilled through the spacer 14. A first bolt hole 42a is drilled at a distance of 1¼″ from the top 44 of the spacer 14 and ¾″ from the right side 46 to a center point of the bolt hole 42a leaving a distance of 3¼″ from the bottom 48 of the spacer 14 to the center point of the first bolt hole 42a. A second bolt hole 42b is drilled at a distance of 1¼″ from the top 44 of the spacer 14 and ¾″ from the left side 50 to a center point of the bolt hole 42b also leaving a distance of 3¼″ from the bottom 48 of the spacer 14. The distance between the center points of the bolt holes 42 is therefore 2½″. A perspective view of the spacer 14 is shown in FIG. 3D.

As shown in FIGS. 4A-4D, the latch 16 is cut from the remainder of the wooden board to a length L_{L} of 11″. The latch 16 therefore has the same depth D_{L} of 2″ and width W_{L} of 4″. Two bolt holes 52, each having a ⅝″ diameter, are drilled through the latch 16. A first bolt hole 52a is drilled at a distance of 1¼″ from the top 54 of the latch 16 and ¾″ from the right side 56 to a center point of the bolt hole 52a leaving a distance of 9¾″ from the bottom 58 of the latch 16 to the center point of the first bolt hole 52a. A second bolt hole 52b is drilled at a distance of 1¼″ from the top 54 of the latch 16 and ¾″ from the left side 60 to a center point of the bolt hole 52b also leaving a distance of 9¾″ from the bottom 58 of the latch 16.

A slot S is formed in the latch 16 by drilling a 1″ diameter hole 62 at a distance to the center point of the hole 62 of 6½″ from the bottom 58 and 2″ from the right side 56 and the left side 60 of the latch 16. The slot S is cut out by cutting from the bottom 58 at a distance of 1½″ from the right side 56 to a point 64 along the circumference of the drilled hole 62 and from a distance of 1½″ from the left side 60 to a point 66 to form a uniform 1″ diameter slot S having a semicircular upper portion formed from the 1″ diameter hole 62. As shown in FIG. 4E, the slot S is formed between two extensions or tangs 68 that will latch around a door knob or door handle. The inner surfaces 70 of the tangs 68 may be sanded or painted to have the latch 16 easily slide around the stem or shank of a door knob or door handle. The outer surface 61 of the left side 56 or right side 60 of the tangs 68 may be sufficiently smooth to align with and make contact along an interior surface 82 of the door jamb 74 as described herein.

In this embodiment, the bolt holes 28 can accommodate the carriage bolts 18 that are 8″ in length and have a diameter of ⅜″. To assemble the Van Buren Barricade 10, a carriage bolt 18 is inserted through the first bolt hole 52a in the latch 16, through the first bolt hole 42a in the spacer and the first bolt hole 36a in the brace 12. A butterfly nut 20 or other fastener is tightened onto the carriage bolt 18. By using a butterfly nut 20, the wings 21 may be hand tightened making the Van Buren Barricade 10 easy to assembly. A second carriage bolt 18 is inserted through the second bolt hole 52b in the latch 16, through the second bolt hole 42b in the spacer and through the second bolt hole 36b in the brace 12. By using two carriage bolts 18 and having a distance of 2½″ between the bolt holes, stresses are distributed across the face of the latch 16 and spacers 14 preventing splintering of a Van Buren Barricade 10 made of wood or deformation if a plastic or other composite material is used.

Once assembled as shown in FIG. 5, the Van Buren Barricade 10 may be installed to a door 70 by aligning the latch 16 over a door handle 72 with the notches 22 of the brace 12 mating with the door jamb 74. The Van Buren Barricade 10 when installed may partially cover a door lock 76 and prevent the insertion of a key or any other item through a key hole. The door jamb 74 has an interior casing 78, two side jambs 80 and a head jamb (not shown). Each side jamb 80 has an interior surface 82 that the right side 56 of the latch 16 may come in contact with and be slid along as the slot S of the latch 16 is inserted over and around the door handle 72, as shown in FIG. 6. In other embodiments of the Van Buren Barricade 10, the spacers 14 and latch 16 may be installed on the opposite end of the brace 12 to accommodate doors 70 that have the door handle 72 on the right side of the door instead of the left.

The Van Buren Barricade 10 is light weight and easy to maneuver with the spacers 14 providing the proper offset distance from the surface of the door 70 and the face 84 of the interior casing 78. Any number of spacers 14 or no spacers may be used. Preferably by stacking the spacers 14, the spacers 14 may be formed from the same board, rod, or pipe that the brace 12 and latch 16 are formed from, thereby keeping the costs to manufacture the Van Buren Barricade 10 at a minimum. The notches 22, while not necessary, prevent lateral movement of the Van Buren Barricade 10 by having the sidewalls 26 of each notch 22 wrap around the edges 86 of the interior casing 78. Once in place, the tangs 68 of the latch 16 extend a sufficient distance beyond stem 88 of the door handle 72 so that no additional adjustments or tightening of fasteners such as the thumb screws or butterfly nuts 20 of the Van Buren Barricade 10 are needed to secure the door 70 and prevent the door 70 from being pulled from the outside and opened. The extended length of the inner tang 68a and outer tang 68b and narrow slot S is dimensioned for a close-fit around the stem 88 to prevent the door handle 72 or door knob from being turned and pulled or aligned with and pulled through the slot S. Embodiments of the Van Buren Barricade 10 are also formed from adequate dimensions to provide for the inner tang 68a to be wedged between the stem 88 and the side jamb 80 providing a tight fit and bracing the latch 16 against interior surface 82 of the side jamb 80 for more support and providing an indication to the teacher, faculty member or other installer that the Van Buren Barricade 10 is securely in place.

The ends 28 and 30 of the brace 12 of the Van Buren Barricade 10 once installed, extend out beyond the width of a door jamb 74 and in this embodiment, three spacers 14 provide the offset distance O from the surface of the door 70 to secure each end 28 and 30 of the brace 12 against the interior casing 70, as shown in FIG. 7. The offset distance O set by the width of the side jamb 80 and the depth of the interior casing 78 may not be of a standard size, so any number of spacers 14 may be cut and used to accommodate various door jamb sizes. The dimensions given in this embodiment are all approximate dimensions suitable for a standard door having a width of 36″. However, while not all doors may be of a standard size, the backset or distance from the edge 90 of the door 70 that aligns along the exterior casing of the door jamb 74 to the center C of the bore hole for the door handle 72, as shown in FIG. 8, has standard sizes of 2⅜″ or 2¼″ for residential doors in the United States. The depth D of the side jamb 80 or door stop is also commonly in standard sizes of ⅜″ or ⅝″ therefore the latch 16 of the Van Buren Barricade 10 will fit securely around and over most door knobs or door handles and align along the interior surface 82 of the side jamb 80. In preferred embodiments, the outer surface 61 of the right side 56 or left side 60 in alternative embodiments will abut the interior surface 82 of the side jamb 80 creating a somewhat frictional fit and locking the Van Buren Barricade 10 in place. The contacting of the side 56 or 60 of the latch 16 with the side jamb 80 may provide some additional structural support, however even if a small space is provided between the latch 16 and side jamb 80, the Van Buren Barricade 10 will securely hold and prevent the door 70 from being opened even when the exterior door handle is strongly pulled.

As shown in cross-section in FIG. 9 along section A-A of FIG. 8, the door jamb 74 has an exterior casing 92 that the edge 90 of the door aligns against when the door 70 is closed. The interior surface 94 of the door 70 abuts against the exterior surface 96 of the side jamb 80 which with the outer casing 78 may, particularly in metal door jambs, have the door jamb 74 be formed in a single piece of material. In this cross-sectional view, the latch 16 abuts along the interior surface 82 of the side jamb 80 and the spacers 14 set the offset distance O so that the latch 16 extends over the stem 88 and behind the door handle 72. The carriage bolts 18 extend through the latch 16, spacers 14 and brace 12 and are tightened using the wings 21 of the butterfly nuts 20 to provide for hand-tightening of the Van Buren Barricade assembly 10. Once tightened, the Van Buren Barricade 10 unlike the barricades of the prior art requires no further adjustment, but instead is simply installed over the door handle 72 and will hold the door securely shut. While an embodiment with specific dimensions has been described, other suitable dimensions for the brace 12, spacers 14, latch 16 and bolts or other attachment fixtures for doors and door jambs of different sizes are within the scope of the present invention. In other embodiments, the Van Buren Barricade 10 may be formed by cutting a square or rectangular shaped metal rod, PVC tube or other sufficiently resilient material to form the brace 12, one or more spacers 14 and the latch 16 and by cutting a slot S in the latch 16. The number of spacers 14 needed is determined by the dimensions of the board, rod or tube chosen and the offset distance O from the surface of the door 70 to the face 84 of the interior casing 78. In some embodiments, a spacer 14 may not be needed and the Van Buren Barricade 10 is formed from only the brace 12 and latch 16.

An embodiment of the Van Buren Barricade as described herein includes:

1. Two—8 inches long by ⅜-inch carriage bolts

2. Two—⅜-inch butterfly nuts

3. One—48 inches long, 2 inches deep and 4 inches wide brace with notches formed by routing sections of 2¼″ inches wide×¼″ inch deep

4. Three—4½″ inches long 2 inches deep and 4 inches wide spacers

5. One—11 inches long 2 inches deep and 4 inches wide latch with a 1-inch slot cut 6.5 inches from the end terminating in a 1-inch diameter hole

Relationship Between the Components:

All of the components come together to form one structure which is held together by the 8 inches long carriage bolts 18. The Van Buren Barricade 10 is light weight (approximately 5 pounds) and easily carried by any adult or child. It takes about 2 to 3 seconds to slip over the door handle and secure the door. It is designed for doors which open outward for example into a corridor from a classroom.

How the Invention Works:

In a panic situation for example as has happened in schools around the United States there is little time to respond. The Van Buren Barricade 10 would be stored in a location inside the classroom which the teacher has quick access to, and upon need, would be easily retrieved. The Van Buren Barricade 10 would then be carried to the door 70 and slipped over the door handle 72 with both ends 28 and 30 locked on to the interior casing 78 of the door jamb 74. The tangs 68 of the latch 16 extend over and around the door handle 72 and the notches 22 wrap around the interior casing 78, taking only seconds to fully install the Van Buren Barricade 10 and secure the door 70. The Van Buren Barricade 10 requires no further adjustment to secure the door 70 in a closed position, however if necessary the thumb screws or butterfly nuts 20 could be tightened but once assembled retightening of the Van Buren Barricade 10 would in most cases not be necessary. The teacher and students could then take cover away from the door until police arrive. During an exercise at Hudson High School an early prototype of this device was demonstrated to the Hudson Police department who favorably noted its use.

How to Make the Invention:

The device was built by the inventor using only a table saw & electric drill. Since all elements necessary to build the device are available at any lumber yard such as a 2×4 board, bolts, and nuts, anyone can build this device easily and inexpensively, an important concern in less affluent school districts having many classrooms that each would require the Van Buren Barricade 10. The Van Buren Barricade 10 may optionally be painted or otherwise treated to provide smooth surfaces and an appropriate appearance. The components for this very simple device when assembled as shown operate as planned and perform the function of securing an outward swinging door.

How to Use the Invention:

As an example, when a code red is announced at a school, or other similar emergency, the teacher would immediately respond by retrieving the Van Buren Barricade 10 from its stored location. He or she would then slide the Van Buren Barricade 10 over the door handle 72 and align the notches 22 of the brace 12 to interlock with the interior casing 78 of the door jamb 74. If necessary, the two butterfly nuts 20 could be tightened. Once that is done the door 70 is secure. Students and teacher would then take cover until police arrive. An important feature of this device is speed. Most horrible casualties happen within minutes of the beginning of a code red at schools. The installation of this device in seconds protects students and teachers quickly from a perpetrator entering their classroom. Additionally, the Van Buren Barricade 10 need not only be used in school classrooms. It could be used in any setting where security is needed to prevent access by unwanted persons.

Although specific embodiments of the invention have been disclosed herein in detail, it is to be understood that this is for purposes of illustration. This disclosure is not to be construed as limiting the scope of the invention, since the described embodiments may be changed in details as will become apparent to those skilled in the art in order to adapt the barricade to particular applications, without departing from the scope of the following claims and equivalents of the claimed elements.

What is claimed is:

1. A door barricade comprising:
a brace;
at least one spacer affixed to the brace;
a latch affixed to the at least one spacer, the latch having a slot; and
wherein the slot of the latch is inserted over a door handle, and the brace is secured against a door jamb to secure a door in a closed position.

2. The door barricade of claim 1 wherein no further adjustment of the brace, spacers or latch is needed to secure the door in a closed position.

3. The door barricade of claim 1 wherein the brace, at least one spacer and the latch are formed from a single piece of board, rod, or tube.

4. The door barricade of claim 1 wherein the number of spacers is determined by the offset distance from the surface of the door to the face of the interior casing.

5. The door barricade of claim 1 comprising at least one bolt and at least one thumb screw to affix the latch to the spacer and the spacer to the brace.

6. The door barricade of claim 5 wherein the thumb screw secures the bolt by hand tightening.

7. The door barricade of claim 1 comprising two bolt holes aligned through each of the brace, at least one spacer and latch, and wherein the two bolt holes are positioned on either side and above the slot of the latch.

8. The door barricade of claim 7 wherein the two bolt holes are at a distance closer to the top of the brace, the top of the at least one spacers and the top of the latch.

9. The door barricade of claim 1 wherein the latch having tangs that form the slot and an outer surface of one of the tangs is in contact with the interior surface of the doorjamb.

10. The door barricade of claim 1 wherein the brace having notches.

11. A door barricade comprising:
a board that is cut to form a brace, at least one spacer, and a latch having a slot; and
wherein the at least one spacer is affixed to the brace, the latch is affixed to the at least one spacer, and the slot of the latch is inserted over a door handle, and the brace is secured against a door jamb to secure a door in a closed position.

12. The door barricade of claim 10 wherein no further adjustment of the brace, spacers or latch is needed to secure the door in a closed position.

13. The door barricade of claim 10 wherein the number of spacers is determined by the offset distance from the surface of the door to the face of the interior casing.

14. The door barricade of claim 10 comprising at least one bolt and at least one thumb screw to affix the latch to the spacer and the spacer to the brace by hand tightening.

15. The door barricade of claim 10 comprising two bolt holes aligned through each of the brace, at least one spacer and latch; and
wherein the two bolt holes are on either side and above the slot of the latch, and at a distance closer to the top of the brace, the top of the at least one spacers and the top of the latch.

16. A method of making a door barricade, comprising:
cutting a board to form a brace, at least one spacer and latch;
forming a slot in the latch;
affixing the brace to the at least one spacer;
affixing the spacer to the latch; and
inserting the door handle of a door into the slot and aligning the brace against a door jamb of the door to prevent the door from being opened.

17. The method of making a door barricade of claim 16, comprising:
forming the slot by drilling a hole in the latch; and
cutting from a bottom edge of the latch to points on the circumference at the diameter of the hole.

18. The method of making a door barricade of claim 16, comprising:
drilling at least one bolt hole through each of the brace, at least one spacer and latch so that the bolt holes are an equal distance from the top and sides of each of the brace, at least one spacer and latch to insert a bolt through the bolt hole and affix the at least one spacer to the brace and the latch to the at least one spacer.

19. The method of making a door barricade of claim 16, comprising:
drilling a first bolt hole through each of the brace, at least one spacer and latch so that the bolt holes are an equal distance from the top and a side of each of the brace, at least one spacer and latch to insert a bolt through the bolt hole and affix the at least one spacer to the brace and the latch to the at least one spacer;
drilling a second bolt hole through each of the brace, at least one spacer and latch so that the bolt holes are an equal distance from the top and the other side of each of the brace, at least one spacer and latch to insert a bolt through the bolt hole and affix the at least one spacer to the brace and the latch to the at least one spacer.

20. The method of making a door barricade of claim 16, comprising:
routing out notches in the brace.
